(19) United States
(12) Patent Application Publication
(10) Pub. No.: US 2019/0249708 A1
(43) Pub. Date: Aug. 15, 2019

(54) GLIDE HOOK FOR USE WITH A SUPPORT ROD AND BEING CONFIGURED FOR SUPPORTING AN ARTICLE

(71) Applicant: TOWN & COUNTRY LINEN CORP., New York, NY (US)

(72) Inventors: Jeffrey Beyda, New York, NY (US); Gina Barnaba, New York, NY (US); Jennifer Roy, New York, NY (US)

(21) Appl. No.: 16/021,989

(22) Filed: Jun. 28, 2018

Related U.S. Application Data
(60) Provisional application No. 62/630,095, filed on Feb. 13, 2018.

(51) Int. Cl. F16B 45/00; A47K 3/38

(52) U.S. Cl. CPC F16B 45/00; A47K 3/38

(57) ABSTRACT

A glide accessory for coupling to an upper hook portion of a hook that is configured to be hung on a support rod. The glide accessory comprises an arcuate shaped body having a bottom surface and an opposing top surface. The bottom surface is a smooth surface and an arcuate shaped channel is formed in the arcuate shaped body and is open along the top surface and open at first and second ends of the arcuate shaped body. The glide accessory mates with the upper hook portion by receiving the bottom surface of the upper hook portion into the arcuate shaped channel.

### CROSS-REFERENCE TO RELATED APPLICATION

The present application claims priority to and the benefit of U.S. patent application Ser. No. 62/630,095, filed Feb. 13, 2018, which is hereby incorporated by reference in its entirety.

### TECHNICAL FIELD

The present invention is directed to accessories that are used with support rods and more particularly, relates to a hook that includes an accessory that mates with the hook and promotes gliding of the hook over a support rod.

### BACKGROUND

Support rods are used in a number of different settings in a typical house. One of the most common settings is the bathroom and in particular, a shower curtain rod is in the form of a support rod that is configured to mount between supports surfaces (walls). The shower curtain itself is most often hung using a plurality of hooks that include hook portions at first ends that receive the support rod and include attachment structures at opposite second ends for allowing attachment of the shower curtain to the hooks. The hook portions are thus curved so as to receive and be supported on the top portion of the support rod and the shower curtain is moved axially along the support rod by sliding the shower curtain over the support rod. The hook portions thus slide along the support rod during movement of the shower curtain.

Most often these hooks are formed of either a plastic material or a metal material with metal hooks presenting a more elegant appearance and are also more robust as well. However, one of the disadvantages of using metal hooks is that the metal on metal contact between the metal hooks and metal support rod creates friction and as a result, the dragging of the metal hooks across the support rod mars the top surface of the support rod. Not only does such action mar (scratch) the surface of the support rod but also an unpleasant noise is generated. One commercially available product that attempts to address these concerns is a product that incorporates a plurality of rollers that independently rotate about the hook portion of the hook. However, this product is very costly to manufacture and while, these rollers are intended to facilitate axial movement (sliding) of the hooks along the support rod, this product still mars the surface of the support rod and also generates unpleasant noise. There is therefore a need for a solution to these issues and to provide an improved gliding hook.

### SUMMARY

A glide accessory for coupling to an upper hook portion of a hook that is configured to be hung on a support rod. The glide accessory comprises an arcuate shaped body having a bottom surface and an opposing top surface. The bottom surface is a smooth surface and an arcuate shaped channel is formed in the arcuate shaped body and is open along the top surface and open at first and second ends of the arcuate shaped body. The glide accessory mates with the upper hook portion by receiving the bottom surface of the upper hook portion into the arcuate shaped channel. The glide accessory is preferably formed as a rigid plastic structure with a smooth bottom surface that is intended to contact and glide across the upper surface of the support rod. By providing and attaching the glide accessory to the upper hook portion, the upper surface of the support rod is protected since the glide accessory provides a protective interface element with the upper surface of the support rod. The glide accessory thus prevents marring of the support rod that would otherwise occur from a metal support hook continuously sliding across the metal support rod. The glide accessory can mate with the upper hook portion using a mechanical fit, such as a snap-fit.

### BRIEF DESCRIPTION OF THE DRAWING FIGURES

FIG. 1 is a side elevation view of a hook including a glide accessory of the present invention mated to the hook;

FIG. 2 is a top plan view thereof;

FIG. 3 is a side of the glide accessory;

FIG. 4 is a right-side elevation view of the glide accessory, the left side being a mirror image thereof;

FIG. 5 is a top plan view of the glide accessory;

FIG. 6 is a bottom plan view of the glide accessory;

FIG. 7 is a side elevation view of the glide accessory;

FIG. 8 is a cross-sectional view taken along the line A-A of FIG. 7; and

FIG. 9 is a side elevation view showing a hook according to another embodiment with the glide accessory attached thereto and being shown in relationship with a support rod that is shown in cross-section.

### DETAILED DESCRIPTION OF CERTAIN EMBODIMENTS

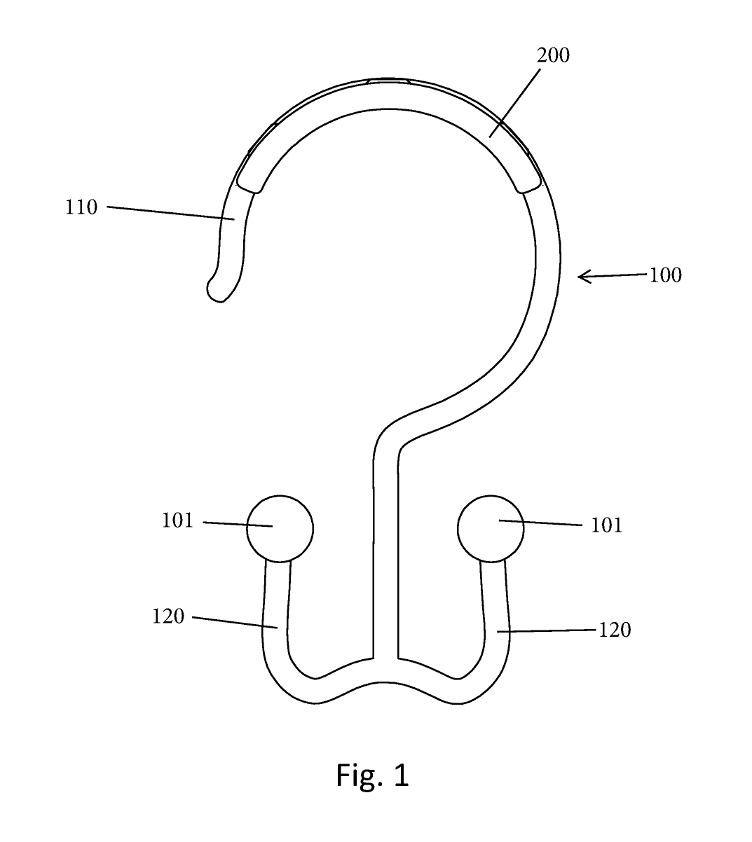

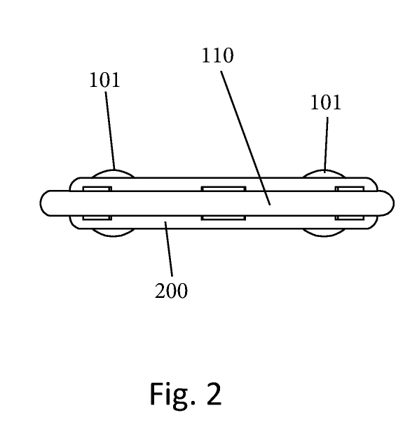

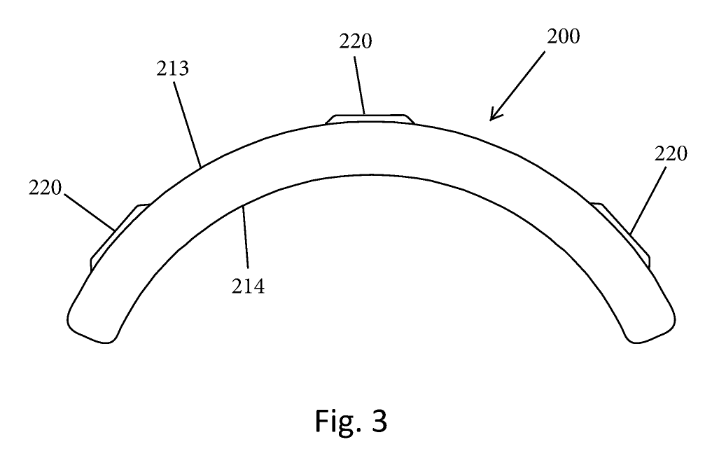

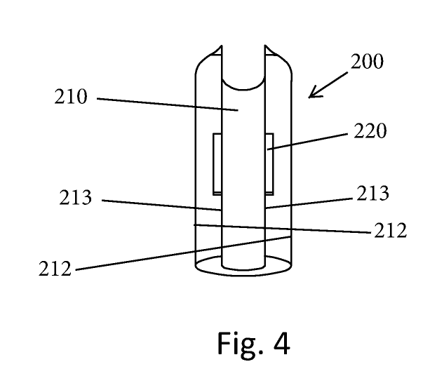

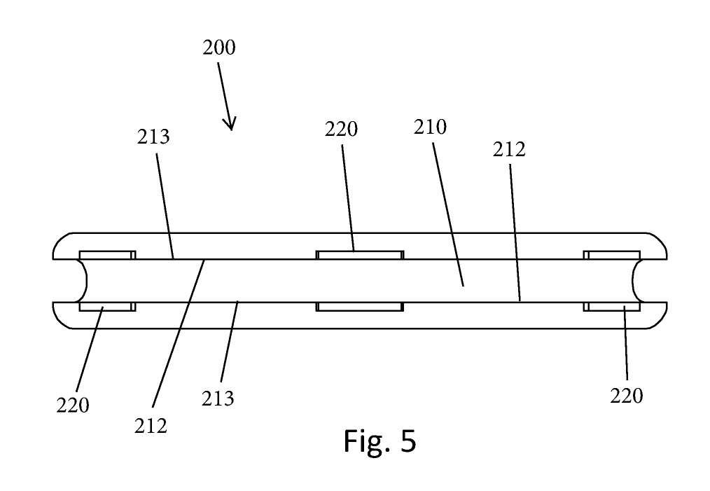

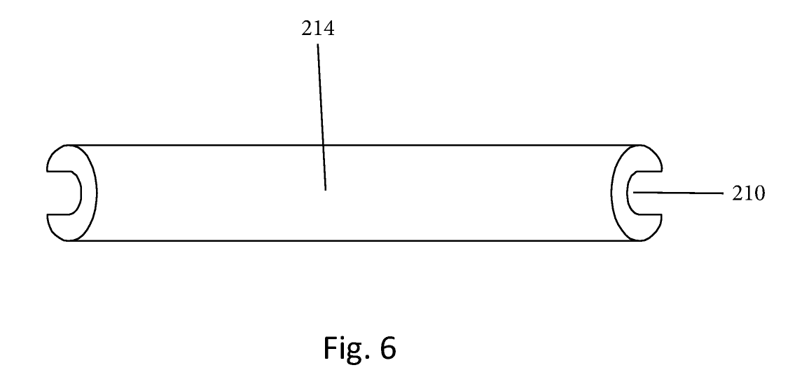

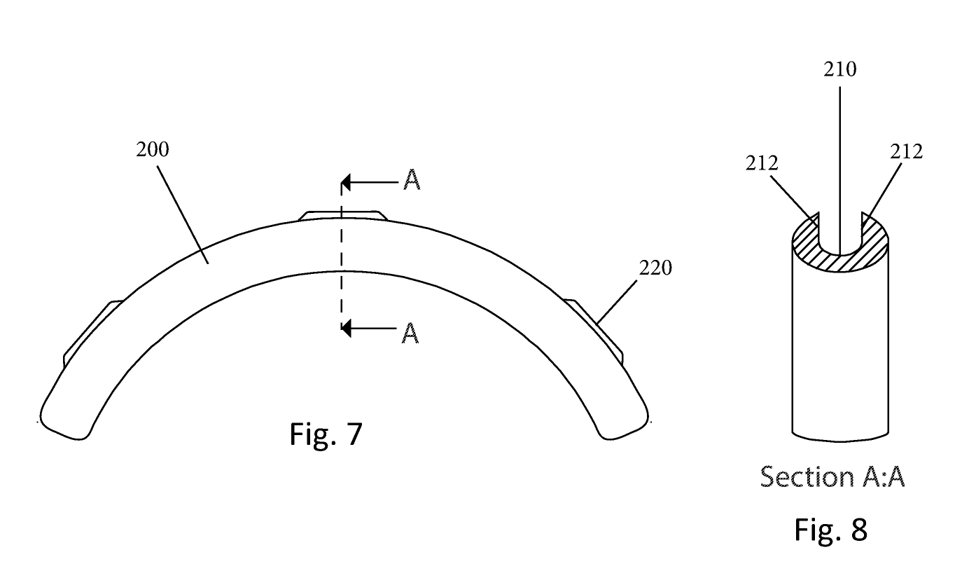

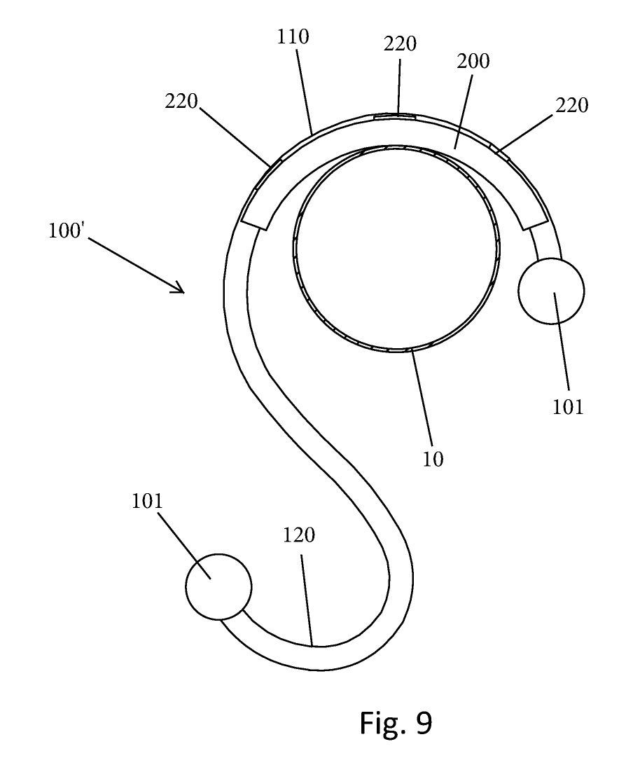

FIGS. 1-8 illustrate a hook 100 in accordance with the present invention. As illustrated, the hook 100 is configured to be supported on a support rod 10 (See, FIG. 9), such as a shower rod. The support rod 10 is an elongated rod structure defined by a diameter D1 and is most often formed of a metal material and is tubular in form.

The illustrated hook 100 can be of a type that can be thought of as being an S-shaped hook 100′ (FIG. 9) or can take other forms, such as the hook 100 shown in FIGS. 1-8. In many embodiment, including those illustrated, the hook 100 includes an upper hook portion 110 and at least one lower hook portion 120. The curvature of the upper hook portion 110 can be greater than the curvature of the lower hook portion 120 to allow the upper hook portion 110 to receive and hang on the support rod. The lower hook portion 120 is the section of the hook on which the suspended article, such as a shower curtain, is suspended. For example, the shower curtain can contain grommets or the like into which the lower hook portion 120 is received and hooked onto. The hook 100 can be formed of a bent wire and therefore, the hook 100 most often has a circular cross-section.

Since the support rod is circular in shape, the upper hook portion 110 has a complementary curved configuration to allow the upper hook portion 110 to hang on the support rod. Due to the circular cross-section, the upper hook portion 110 has an upper surface and a lower surface. The upper surface can be thought of as having a semi-circular shape, while the lower surface can also be thought of as having a semi-circular shape. The lower surface is the surface that faces the lower hook portion 120. It is the lower surface of the lower hook portion 120 that contacts the upper half of the support rod and causes the marring of the upper half of the support rod. It will be appreciated that a section (e.g., substantial section) of the lower surface of the lower hook portion 120 is in continuous contact with the upper half of the support rod and it is this section of the lower surface that the present invention is intended to address and provide an improved glide surface at such location.

Ends of the hook 100 can include decorative and functional elements, such as the illustrated balls 101, that are enlarged relative to the main wire portion of the hook 100.

In accordance with the present invention, a glide accessory 200 is provided and mates with the hook 100 such that the glide accessory 200 is securely attached to the hook 100. As shown and described herein, the glide accessory 200 is configured to mate with the upper hook portion 110 and in particular, the lower surface thereof.

The glide accessory 200 comprises a rigid structure that is configured to mate with and attach to the upper hook portion 110. The glide accessory 200 has an arcuate shape that complements the arcuate (curved) shaped of the upper hook portion 110 and in particular, complements and mates with the lower surface of the upper hook portion 110. The glide accessory 200 includes an open channel or trough 210 formed therein along its entire arcuate length. The open channel 210 faces and is open in an upward direction with the open channel 210 being sized and configured to receive the upper hook portion 110. The formation of the open channel 210 defines opposing side walls 212 that define the sides of the channel 210. The inner surfaces of the side walls 212 can be at least substantially parallel to one another. As shown in the figures, the floor of the open channel 210 can have a curved shape (e.g., concave shape) to facilitate the curved shape of the hook 100.

As shown in the figures, it will also be appreciated that a bottom surface 214 of the body of the glide accessory 200 is defined by a continuously curved (arcuate) surface. In other words, the bottom surface 214 is free of any points or intersections of walls and is defined by radii which define the bottom surface. In addition, the bottom surface 214 is a smooth surface and lacks any spurs, part lines, seams, etc. to provide a smooth gliding surface.

The two side walls 212 that define the channel 210 have top edges 213 that define the top surface of the glide accessory 200. In accordance with the present invention, each of the top edges 213 includes a tab 220 that extends upwardly from the respective top edge 213 and contacts the upper hook portion 110 to facilitate holding the glide accessory 200 onto the upper hook portion 110. The tabs 220 thus provide additional body material that grasps the upper hook portion 110 to facilitate holding the glide accessory 200 onto the upper hook portion 110. In one embodiment, a mechanical fit is established between the glide accessory 200 and the upper hook portion 110 and in particular, the glide accessory 200 is snap-fit to the upper hook portion 110. The tabs 220 facilitate said snap-fit between the glide accessory 200 and the upper hook portion 110 without significantly covering the top surface of the upper hook portion 110. Alternatively, a bonding process or adhesive agent can be used to securely attach the glide accessory 200 to the upper hook portion 110.

It will be appreciated that the number and/or shapes of the tabs 220 can vary. For example and as illustrated, each top edge 213 can have a plurality of tabs 220 that protrude upwardly therefrom. The tabs 220 are spaced apart from one another along the length of the arcuate shaped top edge 213. The illustrated tab 220 can have a generally linear top edge with end walls leading from the top surface of the top edge 213 to this linear top edge. However, it will be appreciated that this top edge of the tab 220 can be arcuate in shape or have other shapes. In addition, the ends of the tabs 220 can also have other shapes than that illustrated in the figures.

In addition, the tab 220 is formed along the inner edge of the top surface of the glide accessory 200 and thus is at a location that comes into contact with the upper hook portion 110 when the glide accessory 200 is mated to the upper hook portion 110.

The tabs 220 on opposing side walls 212 can be located across from one another and thus can be thought of as being providing in pairs. In the illustrated embodiment, there are three pairs of tabs 220.

Typically, the diameter D1 of the support rod is between about 22 mm and about 25 mm and therefore, the radius of curvature of the upper hook portion 110 is selected so as to cause a substantial portion of the upper hook portion 110 to be in contact with the upper surface of the support rod 10.

One of the advantages of the glide accessory 200 is that it does not cover the top surface of the upper hook portion 110 and thus the glide accessory 200 does not completely cover the upper hook portion 110 and aesthetically the appearance of the upper hook portion 110 is maintained. This is in direct contrast to the rollers incorporated into the prior art hook which do completely encircle the upper hook portion of the hook.

In addition, it will be appreciated that the glide accessory 200 can be formed of a clear plastic material and thus, only minimally obscures the elegant appearance of the hook 100. Alternatively, the glide accessory 200 can have a frosted appearance or any other appearance as well. The glide accessory 200 can be formed of suitable rigid plastic materials including but not limited to: (1) PMMA (poly(methyl methacrylate), also known as acrylic or acrylic glass, which is a transparent thermoplastic often used in sheet form as a lightweight or shatter-resistant alternative to glass; (2) POM (polyoxymethylene), also known as acetal, polyacetal, and polyformaldehyde, is an engineering thermoplastic used in precision parts requiring high stiffness, low friction, and excellent dimensional stability; (3) PC (polycarbonates) are a group of thermoplastic polymers containing carbonate groups in their chemical structures. Polycarbonates used in engineering are strong, tough materials, and some grades are optically transparent; (4) PP (polypropylene), also known as polypropene, is a thermoplastic polymer used in a wide variety of applications; and (5) ABS (acrylonitrile butadiene styrene) is a common thermoplastic polymer.

The glide accessory 200 is preferably formed as part of an injection molding operation and as mentioned herein, the molds are formed such that the curved bottom surface of the glide accessory 200 is smooth and is free of any spurs, part lines, seams, etc. As a result, the glide accessory 200 can easily glide over the upper surface of the support rod.

The dimensions of the glide accessory 200 are selected in view of the dimensions of the section of the lower surface of the upper hook portion 110 that is in contact with the support rod and in particular, the glide accessory 200 is intended to be disposed along a substantial length of the section of the lower surface of the upper hook portion 110 that is in natural contact with the upper surface of the support rod. It is therefore desirable to cover at least a substantial portion of the lower surface of the upper hook portion 110 that naturally contacts and seats against the upper surface of the support rod 10. More specifically, as shown in FIG. 9, when the glide accessory 200 seats against the support rod 10, at least an apex of the upper surface of the support rod 10 contacts the glide accessory 200 and the curvature of the bottom surface of the glide accessory 200 can be such that a gap (air space) is formed between the sides of the support rod 10 and the bottom surface of the glide accessory 200. It will be understood that if the hook 100 shifts relative to the support rod 10, the bottom surface of the glide accessory 200 may contact at least one side of the support rod 10. It will also be understood that the specific degree of surface contact between the glide accessory 200 and the support rod 10 will depend on a number of different parameters including but not limited to the radius of curvature of the glide accessory 200, the radius of curvature of the upper hook portion 110, the diameter of the support rod 10, etc.

In one embodiment, the glide accessory 200 is less than 180 degrees as measured from one end to the other end. However, other angles are equally possible to describe the arcuate length of the glide accessory 200.

The rigid property of the glide accessory 200 ensures that it maintains its form and allows it to mechanically attach to the upper hook portion 110, as by a snap-fit.

It will be understood that the hook 100 can come in many different shapes and sizes. Appendix A sets forth several different types of hooks 100 but is not limiting of the scope of the present invention.

In addition, the glide accessory 200 can be constructed using several different techniques. In one method, the designing of the hook 100 is performed and completed and then the glide accessory is constructed by formation of a mold that ensures the glide accessory 200 is molded to form in view of the properties of the hook 100. In another method, the glide accessory 200 is first designed and then the hook 100 is formed by bending the wire material that forms the hook to the specific geometry of the glide accessory 200. A jig or the like can be used to bend the wire material to form the hook.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A glide accessory for coupling to an upper hook portion of a hook that is configured to be hung on a support rod comprising:
an arcuate shaped body having a bottom surface and an opposing top surface, the bottom surface being a smooth surface and wherein an arcuate shaped channel is formed in the arcuate shaped body and is open along the top surface and open at first and second ends of the arcuate shaped body.

2. The glide accessory of claim 1, wherein the arcuate shaped body is formed of a rigid plastic material.

3. The glide accessory of claim 1, wherein the bottom surface is free of seams.

4. The glide accessory of claim 1, wherein the bottom surface of the arcuate shaped body comprises a continuously arcuate shaped surface.

5. The glide accessory of claim 1, wherein a floor of the arcuate shaped channel is concave shaped.

6. The glide accessory of claim 5, wherein the arcuate shaped channel is defined by a pair of side walls that are at least substantially parallel to one another.

7. The glide accessory of claim 1, further comprising at least one locking tab extending upwardly from the top surface of the arcuate shaped body for engaging the upper hook portion of the hook.

8. The glide accessory of claim 7, wherein an inner surface of the at least one locking tab is aligned with an inner surface of a side wall defining the arcuate shaped channel.

9. The glide accessory of claim 7, wherein the at least one locking tab comprises a first set of locking tabs located along a top edge of one side wall that defines the arcuate shaped channel and a second set of locking tabs located along a top edge of an opposite side wall that defines the arcuate shaped channel.

10. The glide accessory of claim 9, wherein locking tabs of the first set are located directly opposite respective locking tabs of the second set.

11. The glide accessory of claim 9, wherein at least one locking tab of the first set and at least one locking tab of the second set are formed at an apex of the arcuate shaped body.

12. The glide accessory of claim 1, wherein a depth of the arcuate shaped channel is selected such that the upper hook portion protrudes above the top surface of the arcuate shaped body when the glide accessory is attached to the hook.

13. A support hook for hanging on a support rod comprising:
an upper hook portion configured to receive and be supported on the support rod, the upper hook portion having a top surface and a bottom surface; and
a glide accessory having an arcuate shaped body having a bottom surface and an opposing top surface, the bottom surface being a smooth surface and wherein an arcuate shaped channel is formed in the arcuate shaped body and is open along the top surface and open at first and second ends of the arcuate shaped body, wherein the glide accessory is attached to the upper hook portion with the upper hook portion being received within the arcuate shaped channel.

14. The support hook of claim 13, further including a lower hook portion that is integrally attached to the upper hook portion and the support hook is made of metal.

15. The support hook of claim 13, wherein the upper hook portion has a circular cross-sectional shape.

16. The support hook of claim 13, wherein the arcuate shaped body is formed of a rigid plastic material.

17. The support hook of claim 13, wherein the bottom surface is free of seams.

18. The support hook of claim 13, wherein the bottom surface of the arcuate shaped body comprises a continuously arcuate shaped surface.

19. The support hook of claim 13, wherein a floor of the arcuate shaped channel is concave shaped.

20. The support hook of claim 19, wherein the arcuate shaped channel is defined by a pair of side walls that are at least substantially parallel to one another.

21. The support hook of claim 13, further comprising at least one locking tab extending upwardly from the top surface of the arcuate shaped body for engaging the upper hook portion of the hook.

22. The support hook of claim 21, wherein an inner surface of the at least one locking tab is aligned with an inner surface of a side wall defining the arcuate shaped channel.

23. The support hook of claim 22, wherein the at least one locking tab comprises a first set of locking tabs located along a top edge of one side wall that defines the arcuate shaped channel and a second set of locking tabs located along a top edge of an opposite side wall that defines the arcuate shaped channel.

24. The support hook of claim 23, wherein locking tabs of the first set are located directly opposite respective locking tabs of the second set.

25. The support hook of claim 23, wherein at least one locking tab of the first set and at least one locking tab of the second set are formed at an apex of the arcuate shaped body.

26. The support hook of claim 13, wherein a depth of the arcuate shaped channel is selected such that the upper hook portion protrudes above the top surface of the arcuate shaped body when the glide accessory is attached to the hook.
